(19) United States
(12) Patent Application Publication
(10) Pub. No.: US 2025/0327277 A1
(43) Pub. Date: Oct. 23, 2025

(54) DISPLAY SYSTEM AND DISPLAY METHOD

(71) Applicant: Komatsu Ltd., Tokyo (JP)

(72) Inventors: Shun Kawamoto, Tokyo (JP); Tsubasa Hasumi, Tokyo (JP); Li Dong, Tokyo (JP); Shota Hirama, Tokyo (JP)

(73) Assignee: Komatsu Ltd., Tokyo (JP)

(21) Appl. No.: 18/716,532

(22) PCT Filed: Nov. 21, 2022
(86) PCT No.: PCT/JP2022/043037

§ 371 Date: Nov. 18, 2024

(30) Foreign Application Priority Data
Dec. 10, 2021 (JP) 2021-201115

(51) Int. Cl. E02F 9/26; G06Q 50/08

(52) U.S. Cl. CPC E02F 9/261; G06Q 50/08

(57) ABSTRACT

A display system includes: a detection data acquisition unit that acquires detection data indicating a three-dimensional shape of a construction site in which a work machine operates; a three-dimensional data storage unit that stores first detection data indicating the detection data acquired at a first time point; a changed-portion specifying unit that specifies a changed portion between the first detection data and second detection data indicating the detection data acquired at a second time point after the first time point; an update unit that updates a part of the first detection data on the basis of the changed portion; and a display control unit that causes a display apparatus to display the updated first detection data.

### FIELD

The present disclosure relates to a display system and a display method.

### BACKGROUND

In a technical field related to construction management, a construction management system as disclosed in Patent Literature 1 is known.

### CITATION LIST

### Patent Literature

Patent Literature 1: WO 2019/012993 A

### SUMMARY

### Technical Problem

A situation of a construction site changes. For example, a situation of topography of the construction site changes in accordance with a progress of construction. In addition, operation of a work machine changes a situation of the work machine. There is a demand for a technique capable of appropriately confirming a situation of a construction site.

An object of the present disclosure is to confirm a situation of a construction site.

### Solution to Problem

According to an aspect of the present invention, a display system comprises: a detection data acquisition unit that acquires detection data indicating a three-dimensional shape of a construction site in which a work machine operates; a three-dimensional data storage unit that stores first detection data indicating the detection data acquired at a first time point; a changed-portion specifying unit that specifies a changed portion between the first detection data and second detection data indicating the detection data acquired at a second time point after the first time point; an update unit that updates a part of the first detection data on the basis of the changed portion; and a display control unit that causes a display apparatus to display the updated first detection data.

### Advantageous Effects of Invention

According to the present disclosure, it is possible to confirm a situation of a construction site.

### BRIEF DESCRIPTION OF DRAWINGS

FIG. 1 is a schematic view illustrating a construction management system according to an embodiment.

FIG. 2 is a view illustrating a flight vehicle according to the embodiment.

FIG. 3 is a functional block diagram illustrating a display system according to the embodiment.

FIG. 4 is a flowchart illustrating a display method according to the embodiment.

FIG. 5 is a view illustrating one example of a situation of a construction site at a first time point according to the embodiment.

FIG. 6 is a view illustrating the one example of the situation of the construction site at a second time point according to the embodiment.

FIG. 7 is a view for describing another example of a changed-portion specifying method according to the embodiment.

FIG. 8 is a view for describing another example of the changed-portion specifying method according to the embodiment.

FIG. 9 is a view for describing another example of the changed-portion specifying method according to the embodiment.

FIG. 10 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments. Components of the embodiments described below can be appropriately combined. In addition, some of the components may not be used.

### [Construction Management System]

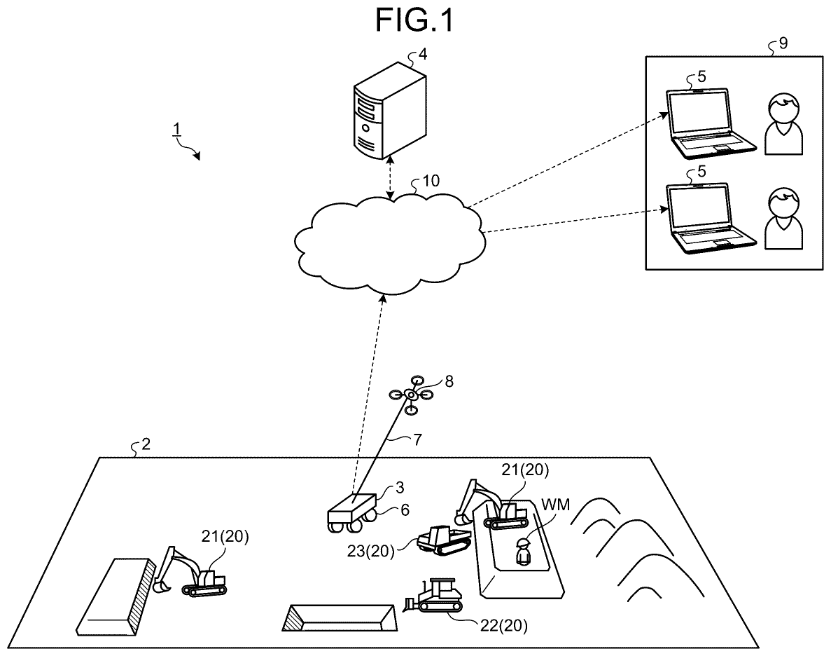

FIG. 1 is a schematic view illustrating a construction management system 1 according to an embodiment. The construction management system 1 manages construction in a construction site 2. A plurality of work machines 20 operate in the construction site 2. In the embodiment, the work machines 20 include a hydraulic excavator 21, a bulldozer 22, and a crawler dump 23. A person WM exists in the construction site 2. As the person WM, a worker who works in the construction site 2 is exemplified. Note that the person WM may be a supervisor who manages construction. The person WM may be a visitor.

As illustrated in FIG. 1, the construction management system 1 includes a management apparatus 3, a server 4, information terminal 5, and a flight vehicle 8.

The management apparatus 3 includes a computer system disposed in the construction site 2. The management apparatus 3 is supported by a traveling apparatus 6. The management apparatus 3 can travel the construction site 2 by the traveling apparatus 6. As the traveling apparatus 6, an aerial work platform vehicle, a truck, and a traveling robot are exemplified.

The server 4 includes a computer system. The server 4 may be disposed in the construction site 2 or may be disposed at a remote location of the construction site 2.

Each of the information terminals 5 is a computer system disposed in a remote location 9 of the construction site 2. As the information terminal 5, a personal computer and a smartphone are exemplified.

The management apparatus 3, the server 4, and the information terminals 5 communicate with each other via a communication system 10. As the communication system 10, the Internet, a local area network (LAN), a mobile phone communication network, and a satellite communication network are exemplified.

The flight vehicle 8 flies in the construction site 2. As the flight vehicle 8, an unmanned aerial vehicle (UAV) such as a drone is exemplified. In the embodiment, the flight vehicle 8 and the management apparatus 3 are connected by a cable 7. The management apparatus 3 includes a power source or a generator. The management apparatus 3 can supply a power to the flight vehicle 8 via the cable 7.

### [Flight Vehicle]

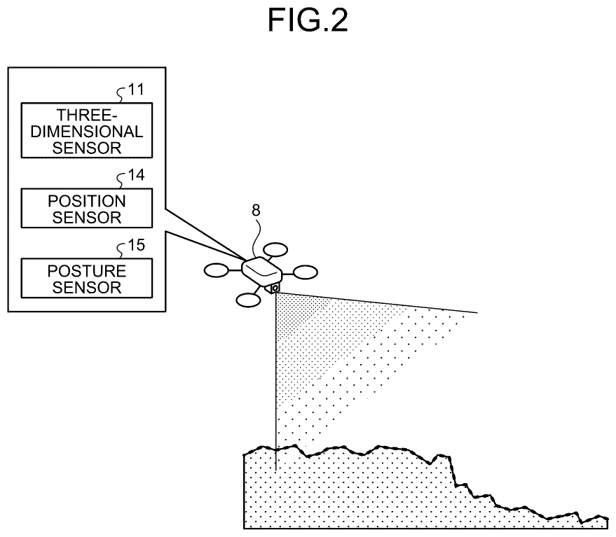

FIG. 2 is a view illustrating the flight vehicle 8 according to the embodiment. A three-dimensional sensor 11, a position sensor 14, and a posture sensor 15 are mounted on the flight vehicle 8.

The three-dimensional sensor 11 detects the

construction site 2. The three-dimensional sensor 11 acquires three-dimensional data indicating a three-dimensional shape of the construction site 2. Detection data of the three-dimensional sensor 11 includes the three-dimensional data of the construction site 2. The three-dimensional sensor 11 is disposed in the flight vehicle 8. The three-dimensional sensor 11 detects the construction site 2 from above the construction site 2. As a detection target of the three-dimensional sensor 11, topography of the construction site 2 and an object existing in the construction site 2 are exemplified. The object includes one or both of a movable body and a stationary body. As the movable body, the work machine 20 and the person WM are 10 exemplified. As the stationary body, wood and materials are exemplified. Note that the three-dimensional data of the construction site 2 may be created using detection data of a two-dimensional sensor such as a monocular camera.

The three-dimensional data acquired by the three-dimensional sensor 11 includes image data of the 15 construction site 2. The image data acquired by the three-dimensional sensor 11 may be moving image data or still image data. As the three-dimensional sensor 11, a stereo camera is exemplified. Note that the three-dimensional 20 sensor 11 may include a monocular camera and a three-dimensional measurement apparatus. As the three-dimensional measurement apparatus, a laser sensor (light detection and ranging (LIDAR)) that detects a detection target by emitting a laser beam is exemplified. Note that 25 the three-dimensional measurement apparatus may be an infrared sensor that detects an object by emitting infrared light or a radar sensor (radio detection and ranging (RADAR)) that detects the object by emitting radio waves.

The position sensor 14 detects a position of the flight vehicle 8. The position sensor 14 detects the position of the flight vehicle 8 using a global navigation satellite system (GNSS). The position sensor 14 includes a GNSS receiver (GNSS sensor), and detects a position in a global coordinate system of the flight vehicle 8. The three-dimensional sensor 11 is fixed to the flight vehicle 8. The position sensor 14 can detect s position of the three-dimensional sensor 11 by detecting the position of the flight vehicle 8. Detection data of the position sensor 14 includes position data of the three-dimensional sensor 11.

The posture sensor 15 detects a posture of the flight vehicle 8. The posture includes, for example, a roll angle, a pitch angle, and a yaw angle. As the posture sensor 15, an inertial measurement unit (IMU) is exemplified. The three-dimensional sensor 11 is fixed to the flight vehicle 8. The posture sensor 15 can detect a posture of the three-dimensional sensor 11 by detecting the posture of the flight vehicle 8. Detection data of the posture sensor 15 includes posture data of the three-dimensional sensor 11.

Each of the detection data of the three-dimensional sensor 11, the detection data of the position sensor 14, and the detection data of the posture sensor 15 is transmitted to the management apparatus 3 via the cable 7. Each of the detection data of the three-dimensional sensor 11, the detection data of the position sensor 14, and the detection data of the posture sensor 15, which are received by the management apparatus 3, is transmitted to the server 4 via the communication system 10.

### [Display System]

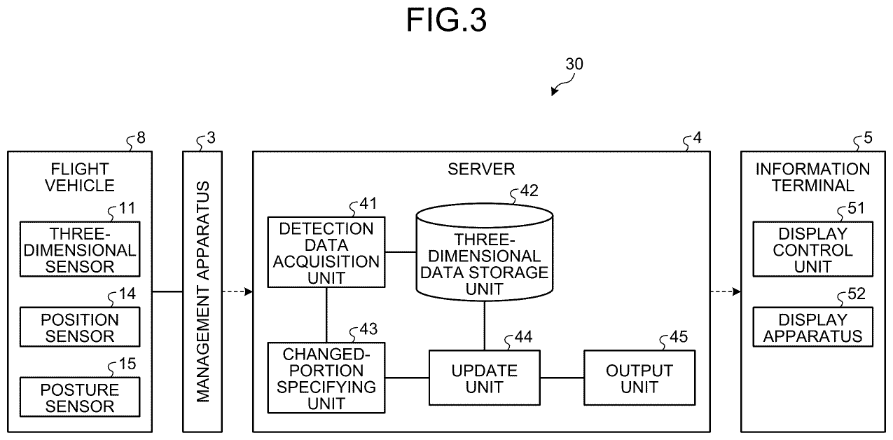

FIG. 3 is a functional block diagram illustrating a display system 30 according to the embodiment. As illustrated in FIG. 3, the display system 30 includes the flight vehicle 8, the management apparatus 3 disposed in the construction site 2, the server 4, and the information terminal 5 disposed in a remote location 9 of the construction site 2.

The flight vehicle 8 has the three-dimensional sensor 11, the position sensor 14, and the posture sensor 15.

The information terminal 5 has a display control unit 51 and a display apparatus 52.

The display apparatus 52 displays display data. A manager of the remote location 9 can confirm the display data displayed on the display apparatus 52. As the display apparatus 52, a flat panel display such as a liquid crystal display (LCD) or an organic electroluminescence display (OELD) is exemplified.

The server 4 has a detection data acquisition unit 41, a three-dimensional data storage unit 42, a changed-portion specifying unit 43, an update unit 44, and an output unit 45.

The detection data acquisition unit 41 acquires the detection data indicating the three-dimensional shape of the construction site 2 from the three-dimensional sensor 11. The detection data acquisition unit 41 acquires the three-dimensional data of the construction site 2 from the three-dimensional sensor 11. The detection data includes at least one of the topography of the construction site 2 and the work machine 20.

The three-dimensional data storage unit 42 stores the detection data acquired by the detection data acquisition unit 41.

The changed-portion specifying unit 43 specifies a changed portion between first detection data indicating detection data acquired at a first time point t1 by the detection data acquisition unit 41 and second detection data indicating detection data acquired at a second time point t2 after the first time point t1.

A detection space of the three-dimensional sensor 11 when the first detection data is acquired, and a detection space of the three-dimensional sensor 11 when the second detection data is acquired are the same detection space.

The update unit 44 updates a part of the first detection data on the basis of the changed portion specified by the changed-portion specifying unit 43.

The output unit 45 outputs, to the information terminal 5, the first detection data updated by the update unit 44. The output unit 45 transmits the first detection data updated by the update unit 44 to the information terminal 5 via the communication system 10.

The output unit 45 transmits, to the display control unit 51, a control command for causing the display apparatus 52 to display the first detection data updated by the update unit 44. On the basis of the control command transmitted from the output unit 45, the display control unit 51 controls the display apparatus 52 so that the first detection data updated by the update unit 44 is displayed on the display apparatus 52.

### [Construction Management Method]

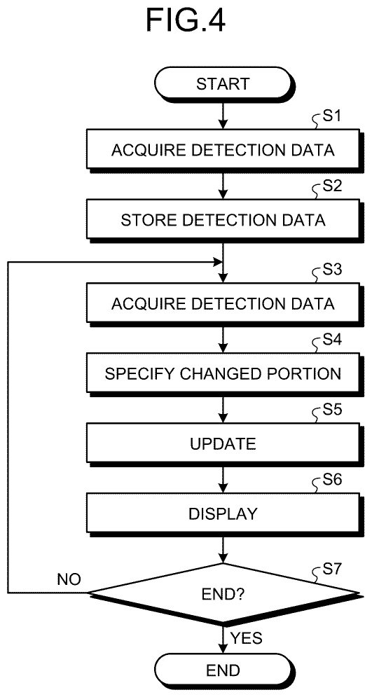

FIG. 4 is a flowchart illustrating a display method according to the embodiment.

When the flight vehicle 8 starts flying above the construction site 2, detection processing of the construction site 2 by the three-dimensional sensor 11 is started. The three-dimensional sensor 11 transmits the detection data to the server 4 at predetermined time intervals.

The detection data acquisition unit 41 acquires the detection data indicating the three-dimensional shape of the construction site 2 from the three-dimensional sensor 11 (step S1).

The three-dimensional data storage unit 42 stores the detection data acquired at a time point of step S1 (step S2).

In the embodiment, the time point of step S1 is appropriately referred to as the first time point t1. The three-dimensional data storage unit 42 stores the first detection data indicating the detection data acquired at the first time point t1.

The detection data acquisition unit 41 acquires the detection data indicating the three-dimensional shape of the construction site 2 from the three-dimensional sensor 11 (step S3).

In the embodiment, a time point of step S3 is appropriately referred to as a second time point t2. After the first detection data acquired at the first time point t1 is stored in the three-dimensional data storage unit 42, the detection data acquisition unit 41 acquires the detection data at the second time point t2 after the first time point t1.

The changed-portion specifying unit 43 specifies the changed portion between the first detection data detected at the first time point t1, and the second detection data acquired at the second time point t2 after the first time point t1 (step S4).

As described above, the detection space of the three-dimensional sensor 11 when the first detection data is acquired and the detection space of the three-dimensional sensor 11 when the second detection data is acquired are the same detection space. That is, the first detection data and the second detection data are detection data in one detection space of the three-dimensional sensor 11. The first detection data and the second detection data are acquired in a state where each of a position and a size of the detection space of the three-dimensional sensor 11 is constant. The changed-portion specifying unit 43 specifies the changed portion between the first detection data detected at the first time point t1 and the second detection data acquired at the second time point t2 after the first time point t1 in the one detection space of the three-dimensional sensor 11.

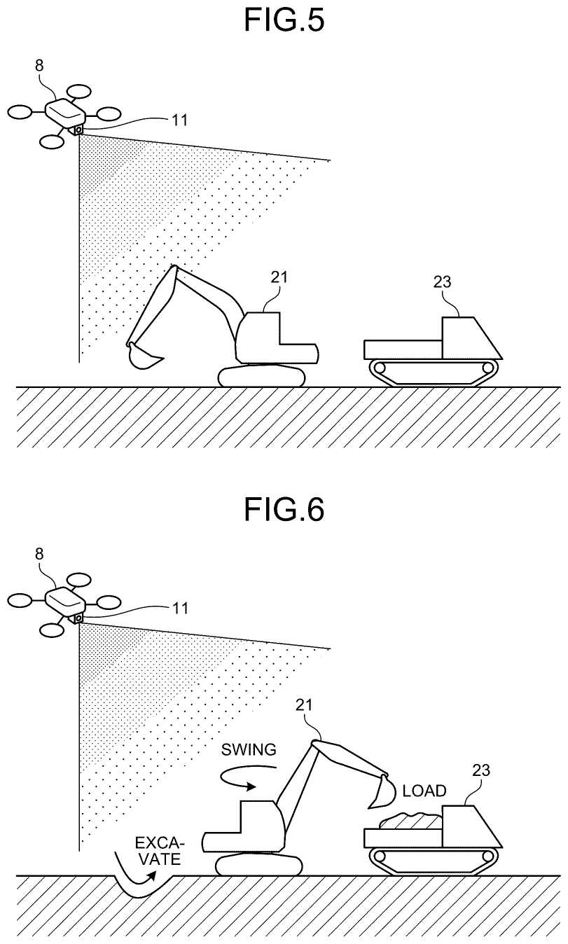

FIG. 5 is a view illustrating one example of a situation of the construction site 2 at the first time point t1 according to the embodiment. FIG. 6 is a view illustrating the one example of the situation of the construction site 2 at the second time point t2 according to the embodiment. As illustrated in FIGS. 5 and 6, the situation of the construction site 2 changes. In the example illustrated in FIGS. 5 and 6, ground of the construction site 2 is not excavated at the first time point t1, but the ground of the construction site 2 is excavated by the hydraulic excavator 21 at the second time point t2. In addition, although the working equipment of the hydraulic excavator 21 faces the ground to be excavated at the first time point t1, an upper swing body of the hydraulic excavator 21 swings so that the working equipment of the hydraulic excavator 21 faces the crawler dump 23 at the second time point t2. In addition, at the second time point t2, the excavated object excavated by the hydraulic excavator 21 is loaded into a dump body of the crawler dump 23. As described above, a situation of the topography of the construction site 2 changes due to a progress of construction, or a situation of the hydraulic excavator 21 changes due to operation of the excavator 21.

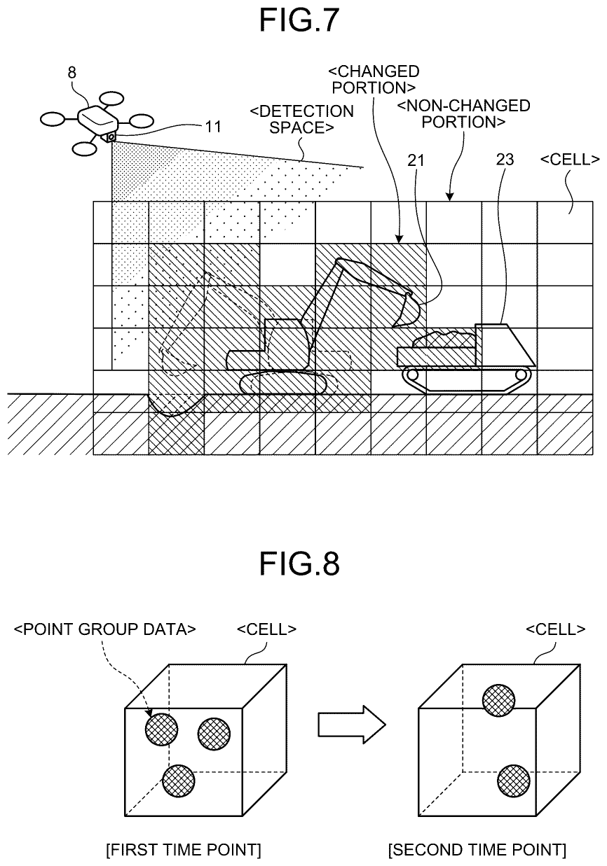

Each of FIGS. 7 and 8 is a view for describing one example of a changed-portion specifying method according to the embodiment.

As illustrated in FIG. 7, the changed-portion specifying unit 43 divides the detection space of the three-dimensional sensor 11 into a plurality of cells. One cell has a rectangular parallelepiped shape. As the cell, a voxel is exemplified. The changed-portion specifying unit 43 determines whether or not the second detection data has changed from the first detection data for each of the plurality of cells, and specifies cells determined to have changed as the changed portion between the first detection data and the second detection data. In the example illustrated in FIG. 7, the changed portion is cells in which the hydraulic excavator 21 exists, cells in which an excavated portion of the ground exists, and a portion in which the dump body loaded with an excavated object exists.

As illustrated in FIG. 8, when the detection data of the three-dimensional sensor 11 includes point group data including a plurality of detection points, the changed-portion specifying unit 43 compares a feature amount of the detection point registered in each cell between the first time point t1 and the second time point t2, and specifies a cell having a large change in the feature amount as the changed portion.

After the changed portion is specified in step S4, the update unit 44 updates a part of the first detection data stored in the three-dimensional data storage unit 42 on the basis of the changed portion (step S5).

The update unit 44 updates only a part of the first detection data identified as the changed portion.

That is, the update unit 44 replaces only a part of the first detection data with the changed portion.

The output unit 45 transmits the first detection data updated in step S5 to the information terminal 5 via the communication system 10. The output unit 45 transmits, to the display control unit 51, the control command for causing the display apparatus 52 to display the updated first detection data. On the basis of the control command transmitted from the output unit 45, the display control unit 51 causes the display apparatus 52 to display the updated first detection data (step S6).

The output unit 45 determines whether or not to end the display of the first detection data (step S7).

When it is determined in step S7 that the display of the first detection data is to be continued (step S7: No), the processing returns to step S3. As a result, on the basis of the changed portion, the detection data indicating the three-dimensional shape of the construction site 2 is continuously updated. The display apparatus 52 displays display data in accordance with the situation of the construction site 2 in real time. When it is determined in step S7 that the display of the first detection data is to be ended (step S7: Yes), the display of the first detection data is ended.

### [Case Where There is Blind Spot Portion in Detection Space]

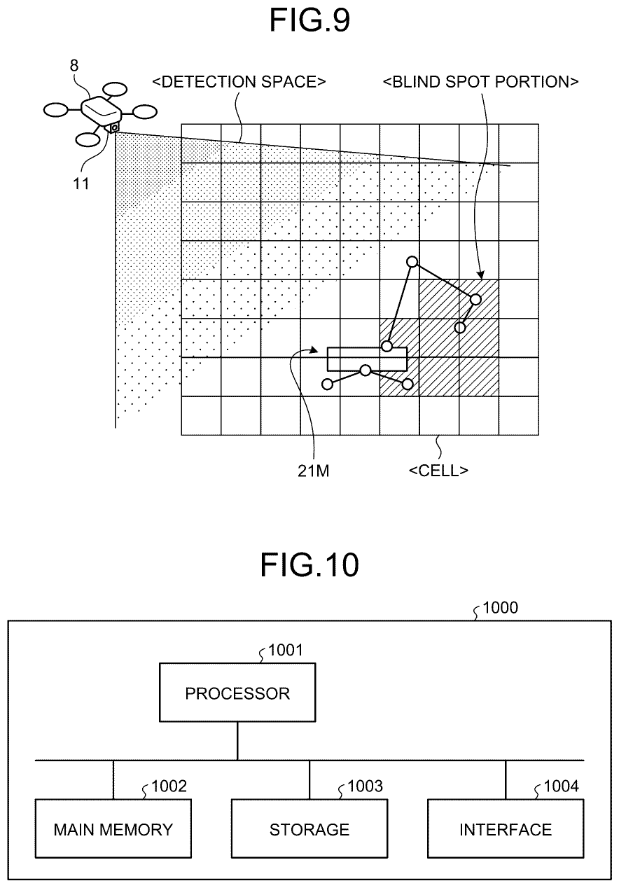

FIG. 9 is a view for describing another example of the changed-portion specifying method according to the embodiment. As illustrated in FIG. 9, there is a possibility that a blind spot portion occurs in the detection space. That is, there is a possibility that a portion that the three-dimensional sensor 11 cannot detect in the construction site 2 occurs. In other words, there is a possibility that a portion not included in the detection data of the three-dimensional sensor 11 is generated. For example, when the blind spot portion occurs in the detection space by the hydraulic excavator 21, the changed-portion specifying unit 43 specifies the point group data corresponding to the hydraulic excavator 21 in the detected point group data. The changed-portion specifying unit 43 can specify the undetected portion of the construction site 2 by applying a three-dimensional model indicating the hydraulic excavator 21 to a position corresponding to the specified hydraulic excavator 21. For example, the changed-portion specifying unit 43 specifies point group data corresponding to a part of the upper swing body and the working equipment in the detected point group data. The changed-portion specifying unit 43 applies a part of the upper swing body and the working equipment of the corresponding three-dimensional model to specified positions of the part of the upper swing body and the working equipment. Even if the working equipment has a blind spot portion, the changed-portion specifying unit 43 can specify the changed portion of the blind spot portion of the working equipment on the basis of the position of the working equipment of the three-dimensional model.

Furthermore, an operation of the hydraulic excavator 21 not included in the detection data may be predicted on the basis of the three-dimensional model of the hydraulic excavator 21. The update unit 44 may update a part of the first detection data on the basis of the prediction of the changed-portion specifying unit 43. For example, in a case where an angle sensor that detects an angle of the working equipment of the hydraulic excavator 21 is provided in the hydraulic excavator 21, the changed-portion specifying unit 43 can predict whether or not the working equipment has operated on the basis of detection data of the angle sensor even when the working equipment is in a blind spot portion. In addition, the changed-portion specifying unit 43 can predict an operation amount of the working equipment on the basis of the detection data of the angle sensor. When predicting that the working equipment has operated, the changed-portion specifying unit 43 specifies cells in which the working equipment is present as the changed portion between the first detection data and the second detection data. The update unit 44 updates a part of the first detection data on the basis of the changed portion.

### [Computer System]

FIG. 10 is a block diagram illustrating a computer system 1000 according to the embodiment. The above-described server 4 includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The above-described function of the server 4 is stored in the storage 1003 as a computer program. The processor 1001 reads the computer program from the storage 1003, develops the computer program in the main memory 1002, and executes the above-described processing in accordance with the program. Note that the computer program may be distributed to the computer system 1000 via a network.

According to the above-described embodiment, the computer program or the computer system 1000 can execute: acquiring the detection data indicating the three-dimensional shape of the construction site 2 in which the work machine 20 operates; storing the first detection data indicating the detection data acquired at the first time point t1; specifying the changed portion between the first detection data and the second detection data indicating the detection data acquired at the second time point t2 after the first time point t1; updating a part of the first detection data on the basis of the changed portion; and causing the display apparatus 52 to display the updated first detection data.

### [Effects]

As described above, according to the embodiment, when the situation of a part of the construction site 2 changes, only the changed portion of the detection data indicating the three-dimensional shape of the construction site 2 stored in the three-dimensional data storage unit 42 is replaced with the latest detection data, and the detection data is updated. By displaying the updated detection data on the display apparatus 52, the manager can confirm the situation of the construction site 2 in real time. In addition, not all of the detection space of the three-dimensional sensor 11 is replaced with the latest detection data, but only the changed portion is replaced with the latest detection data, and thus appropriate detection data is displayed on the display apparatus 52. If all of the detection space of the three-dimensional sensor 11 with the latest detection data is replaced, there is a possibility that a detection density of the three-dimensional sensor 11 decreases, and as a result, there is a possibility that inappropriate detection data is displayed on the display apparatus 52. By replacing only the changed portion in the detection space of the three-dimensional sensor 11 with the latest detection data, it is possible to replace the detection data with the detection data in which the decrease in the detection density is suppressed.

Therefore, proper detection data is displayed on the display apparatus 52.

[Other Embodiments]In the above-described embodiment, the flight vehicle 8 is a wired flight vehicle connected to the cable 7. The flight vehicle 8 may be a wireless flight vehicle that is not connected to cable 7.

In the above-described embodiment, the position sensor 14 is used to detect the position of the flight vehicle 8, and the posture sensor 15 is used to detect the posture of the flight vehicle 8. Simultaneous localization and mapping (SLAM) may be used to detect the position and the posture of the flight vehicle 8. Geomagnetism or a barometer may be used to detect the position and the posture of the flight vehicle 8.

In the above-described embodiment, the management apparatus 3 is supported by the traveling apparatus 6 and can travel in the construction site 2. The management apparatus 3 may be mounted on the work machine 20 or may be installed at a predetermined position in the construction site 2.

In the above-described embodiment, the

information terminal 5 may not be disposed at the remote location 9 of the construction site 2. The information terminal 5 may be mounted on the work machine 20, for example.

In the above-described embodiment, the function of the server 4 may be provided in the management apparatus 3, in the information terminal 5, or in a computer system mounted on the flight vehicle 8. For example, at least one function of the detection data acquisition unit 41, the three-dimensional data storage unit 42, the changed-portion specifying unit 43, the update unit 44, and the output unit 45 may be provided in the management apparatus 3, in the information terminal 5, or in the computer system mounted on the flight vehicle 8.

In the above-described embodiment, each of the detection data acquisition unit 41, the three-dimensional data storage unit 42, the changed-portion specifying unit 43, the update unit 44, and the output unit 45 may be configured by different hardware.

In the above-described embodiment, the three-dimensional sensor 11 may not be disposed in the flight vehicle 8. The three-dimensional sensor 11 may be disposed, for example, in the work machine 20 or in a moving body different from the flight vehicle 8 and the work machine 20. The three-dimensional sensor 11 may be disposed in a structure existing in the construction site 2. In addition, a plurality of three-dimensional sensors 11 may be installed in the construction site 2, and the construction site 2 may be detected over a wide range.

According to the above-described embodiment, the update unit 44 updates a part of the first detection data on the basis of the changed portion specified by the changed-portion specifying unit 43. The changed-portion specifying unit 43 may specify a portion corresponding to the work machine 20 in the specified changed portion. For example, the portion corresponding to the work machine 20 can be specified using artificial intelligence (AI). The update unit 44 may update a part of the first detection data except for the portion corresponding to the work machine 20 in the changed portion.

In the above-described embodiment, the work machine 20 may be a work machine different from the hydraulic excavator 21, the bulldozer 22, and the crawler dump 23. The work machine 20 may include, for example, a wheel loader.

### REFERENCE SIGNS LIST

1 CONSTRUCTION MANAGEMENT SYSTEM
2 CONSTRUCTION SITE
3 MANAGEMENT APPARATUS
4 SERVER (DATA PROCESSING APPARATUS)
5 INFORMATION TERMINAL
6 TRAVELING APPARATUS
7 CABLE
8 FLIGHT VEHICLE
9 REMOTE LOCATION
10 COMMUNICATION SYSTEM
11 THREE-DIMENSIONAL SENSOR
14 POSITION SENSOR
15 POSTURE SENSOR
20 WORK MACHINE
21 HYDRAULIC EXCAVATOR
22 BULLDOZER
23 CRAWLER DUMP
30 DISPLAY SYSTEM
41 DETECTION DATA ACQUISITION UNIT
42 THREE-DIMENSIONAL DATA STORAGE UNIT
43 CHANGED-PORTION SPECIFYING UNIT
44 UPDATE UNIT
45 OUTPUT UNIT
51 DISPLAY CONTROL UNIT
52 DISPLAY APPARATUS
1000 COMPUTER SYSTEM
1001 PROCESSOR
1002 MAIN MEMORY
1003 STORAGE
1004 INTERFACE
WM PERSON

1. A display system comprising:
a detection data acquisition unit that acquires detection data indicating a three-dimensional shape of a construction site in which a work machine operates;
a three-dimensional data storage unit that stores first detection data indicating the detection data acquired at a first time point;
a changed-portion specifying unit that specifies a changed portion between the first detection data and second detection data indicating the detection data acquired at a second time point after the first time point;
an update unit that updates a part of the first detection data on the basis of the changed portion; and
a display control unit that causes a display apparatus to display the updated first detection data.

2. The display system according to claim 1,
wherein the detection data acquisition unit acquires the detection data from a three-dimensional sensor that detects the construction site, and
the changed-portion specifying unit divides a detection space of the three-dimensional sensor into a plurality of cells, determines whether or not the second detection data has changed from the first detection data for each of the plurality of cells, and specifies as the changed portion a cell determined to have changed.

3. The display system according to claim 1,
wherein the detection data includes the work machine,
the changed-portion specifying unit predicts an operation of the work machine not included in the detection data on the basis of a three-dimensional model of the work machine, and
the update unit updates a part of the first detection data on the basis of the prediction.

4. The display system according to claim 1,
wherein the detection data includes topography of the construction site.

5. A display method comprising:
acquiring detection data indicating a three-dimensional shape of a construction site in which a work machine operates;
storing first detection data indicating the detection data acquired at a first time point;
specifying a changed portion between the first detection data and second detection data indicating the detection data acquired at a second time point after the first time point;
updating a part of the first detection data on the basis of the changed portion; and
causing a display apparatus to display the updated first detection data.

6. The display method according to claim 5,
wherein the detection data is acquired from a three-dimensional sensor that detects the construction site, and
a detection space of the three-dimensional sensor is divided into a plurality of cells, it is determined whether or not the second detection data has changed from the first detection data for each of the plurality of cells, and a cell determined to have changed is specified as the changed portion.

7. The display method according to claim 5,
wherein the detection data includes the work machine, and
an operation of the work machine not included in the detection data is predicted on the basis of a three-dimensional model of the work machine and a part of the first detection data is updated.

8. The display method according to claim 5,
wherein the detection data includes topography of the construction site.
